(19) United States
(12) Patent Application Publication
(10) Pub. No.: US 2013/0197982 A1
(43) Pub. Date: Aug. 1, 2013

(54) Game Advertisements

(71) Applicants: Allie K. Watfa, Urbana, IL (US); Dale Nussel, Mahomet, IL (US); John Johlas, Ogden, IL (US)

(72) Inventors: Allie K. Watfa, Urbana, IL (US); Dale Nussel, Mahomet, IL (US); John Johlas, Ogden, IL (US)

(73) Assignee: Yahoo! Inc., Sunnyvale, CA (US)

(21) Appl. No.: 13/363,957

(22) Filed: Feb. 1, 2012

(51) Int. Cl. G06Q 30/02

(52) U.S. Cl. 705/14.12; 705/14.53

(57) ABSTRACT

The present invention provides techniques for dynamically creating and integrating advertisements into video games based at least in part on user interests. Techniques are provided in which user interest information may be obtained substantially in real time. The user interest information and video game information may then be used to generate or select advertisements that may be relevant to the users and still be consistent with the theme of the video game. The advertisements may be dynamically integrated substantially in real time into the video game for presentation to the user.

### BACKGROUND

Advertisers (including proxies, agents, or other entities acting on behalf of or in the interest of advertisers) compete for user attention. By effective referencing and use of topics of interest in their advertising, advertisers grab attention, build rapport with audiences, and increase brand cachet. For example, in maintaining distinctiveness and relevance, advertisers benefit from, among other things, knowledge of interests and trending interests of their target audiences.

One particular target audience of interest to advertisers is users who are play video games. There is a need for techniques for, among other things, the ability to base advertisements that are integrated into video games on the nature and interest of the gamer.

### SUMMARY

Exemplary embodiments of the invention provide methods and systems for dynamically selecting or generating advertisements substantially in real-time, and integrating the advertisements into a video game as a user is actively playing the game.

Information relating to a user's interests may be obtained. The information may include user profile information, search history and/or search trends, email communications, social network communication information including conversations, status updates, etc. In one embodiment, this information may be captured substantially in real time. Additionally, in some embodiments, the user's behavioral and interest pattern may be tracked/monitored substantially in real time by tracking/monitoring user profile information, search history and/or search trends, email communications, social network communication information including conversations, status updates, etc. The user profile information may include for example, the user's age, geographic location, education level, ethnicity, etc.

An advertisement to be inserted into a video game may be selected substantially in real time based at least in part on the information relating to the user's interests and on a theme of the video game that the user is actively playing. In some embodiments, the advertisement may be generated or created substantially in real time based at least in part on the information relating to the user's interests and on the theme of the video game. For example, if the user is playing a medieval themed game, an advertisement for a car would not be consistent with the theme of the game, and would likely ruin the game experience. However, an advertisement for a collector's edition sword, for example, may be selected because it is consistent with the theme of the game.

The advertisement may be integrated substantially in real time into the video game while the user is actively playing the video game. For example, the selected advertisement may be displayed on a billboard which is part of a scene in the video game. In another example, if the user is into construction tools and there is a tool usage in the game, the tool used by the characters in the game may be branded with a specific brand such as Black and Decker. This type of ad selection may be dynamic based on a bidding system for advertisers. Thus different ads may appear on subsequent playing sessions of the same game. The advertisements may include textual, audio, visual, and/or graphical data. In some embodiments, the advertisement may be click-able from within the videogame, and may be accessed directly from video game. This may advantageously result in a higher rate of ad conversions. Users may be given incentives in exchange for allowing advertisements to be displayed in the video game. The incentives may include for example, game credits, deals, coupons, cash rewards and rewards points. The user may configure the game, for example, to see an ad every predetermined number of levels, where higher frequencies of ad display may lead to deeper discounts, or even better future deals/discounts.

### BRIEF DESCRIPTION OF THE DRAWINGS

FIG. 1 is a distributed computer system according to one embodiment of the invention;

FIG. 2 is a flow diagram illustrating a method according to one embodiment of the invention;

FIG. 3 is a flow diagram illustrating a method according to one embodiment of the invention;

FIG. 4 is a flow diagram illustrating a method according to one embodiment of the invention;

FIG. 5 is a block diagram illustrating one embodiment of the invention; and

FIG. 6 is a block diagram illustrating exemplary data structures according to one embodiment of the invention.

While the invention is described with reference to the above drawings, the drawings are intended to be illustrative, and the invention contemplates other embodiments within the spirit of the invention.

### DETAILED DESCRIPTION

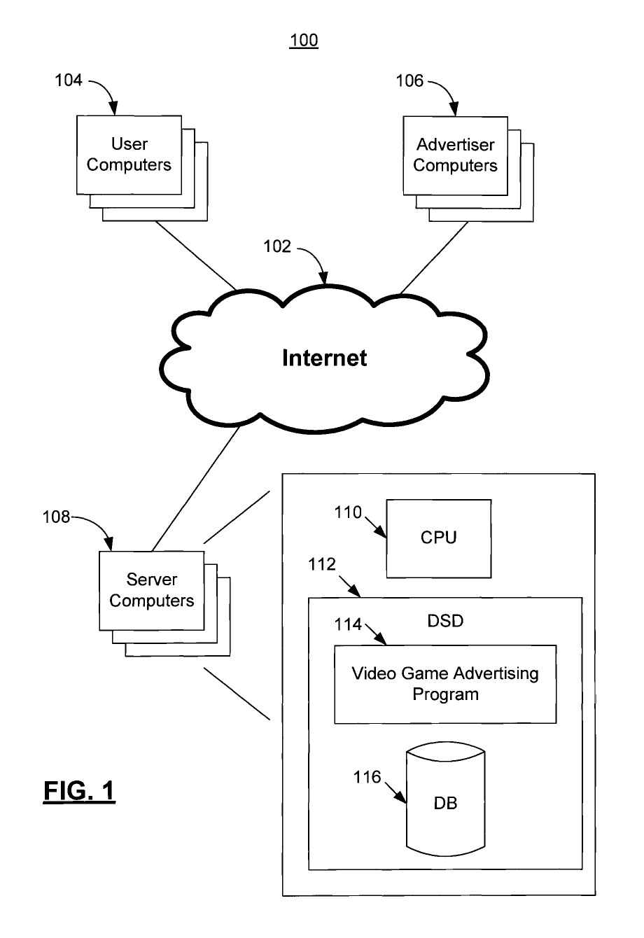

FIG. 1 is a distributed computer system 100 according to one embodiment of the invention. The system 100 includes user computers 104, advertiser computers 106 and server computers 108, all coupled or able to be coupled to the Internet 102. Although the Internet 102 is depicted, the invention contemplates other embodiments in which the Internet is not included, as well as embodiments in which other networks are included in addition to the Internet, including one more wireless networks, WANs, LANs, telephone, cell phone, or other data networks, etc. The invention further contemplates embodiments in which user computers 104 may be portable or handheld devices such as cell phones, PDAs, tablets, mobile navigation units, etc.

Each of the one or more computers 104, 106 and 108 may be distributed, and can include various hardware, software, applications, algorithms, programs and tools. Depicted computers may also include a hard drive, monitor, keyboard, pointing or selecting device, etc. The computers may operate using an operating system such as Windows by Microsoft, etc. Each computer may include a central processing unit (CPU), data storage device, and various amounts of memory including RAM and ROM. Depicted computers may also include various programming, applications, algorithms and software to enable searching, search results, and advertising, such as graphical or banner advertising as well as keyword searching and advertising in a sponsored search context. Many types of advertisements are contemplated, including textual advertisements, graphical advertisements, rich advertisements, video advertisements, etc.

As depicted, each of the server computers 108 includes one or more CPUs 110 and a data storage device 112. The data storage device 112 includes a database 116 and a Video Game Advertising Program 114.

The Program 114 is intended to broadly include all programming, applications, algorithms, software and other and tools necessary to implement or facilitate methods and systems according to embodiments of the invention. The elements of the Program 114 may exist on a single server computer or be distributed among multiple computers or devices.

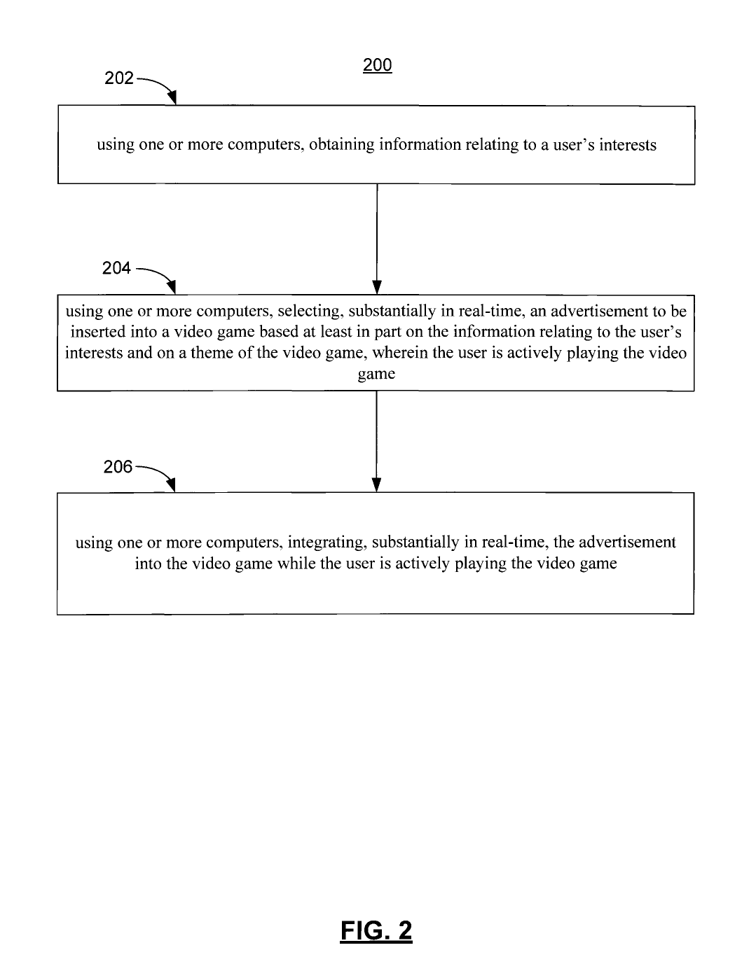

FIG. 2 is a flow diagram illustrating a method 200 according to one embodiment of the invention. At step 202, using one or more computers, information relating to a user's interests is obtained. The information may include user profile information, search history and/or search trends, email communications, social network communication information including conversations, status updates, etc. In one embodiment, this information may be captured substantially in real time. Additionally, in some embodiments, the user's behavioral and interest pattern may be tracked/monitored substantially in real time by tracking/monitoring user profile information, search history and/or search trends, email communications, social network communication information including conversations, status updates, etc. The user profile information may include for example, the user's age, geographic location, education level, ethnicity, etc.

At step 204, using one or more computers, an advertisement to be inserted into a video game may be selected substantially in real time based at least in part on the information relating to the user's interests and on a theme of the video game that the user is actively playing. In some embodiments, the advertisement may be generated or created substantially in real time based at least in part on the information relating to the user's interests and on the theme of the video game. For example, if the user is playing a medieval themed game, an advertisement for a car would not be consistent with the theme of the game, and would likely ruin the game experience. However, an advertisement for a collector's edition sword, for example, may be selected because it is consistent with the theme of the game.

At step 206, using one or more computers, the advertisement may be integrated substantially in real time into the video game while the user is actively playing the video game. For example, the selected advertisement may be displayed on a billboard which is part of a scene in the video game. In another example, if the user is into construction tools and there is a tool usage in the game, the tool used by the characters in the game may be branded with a specific brand such as Black and Decker. This type of ad selection may be dynamic based on a bidding system for advertisers. Thus different ads may appear on subsequent playing sessions of the same game. The advertisements may include textual, audio, visual, and/or graphical data. In some embodiments, the advertisement may be click-able from within the videogame, and may be accessed directly from video game. This may advantageously result in a higher rate of ad conversions. Users may be given incentives in exchange for allowing advertisements to be displayed in the video game. The incentives may include for example, game credits, deals, coupons, cash rewards and rewards points. The user may configure the game, for example, to see an ad every predetermined number of levels, where higher frequencies of ad display may lead to deeper discounts, or even better future deals/discounts. In some embodiments, the price of the game may be determined using: Price of Game=Manufacturer price−(Frequency of ads*WeightFactor)*(% given back*revenue per ad)

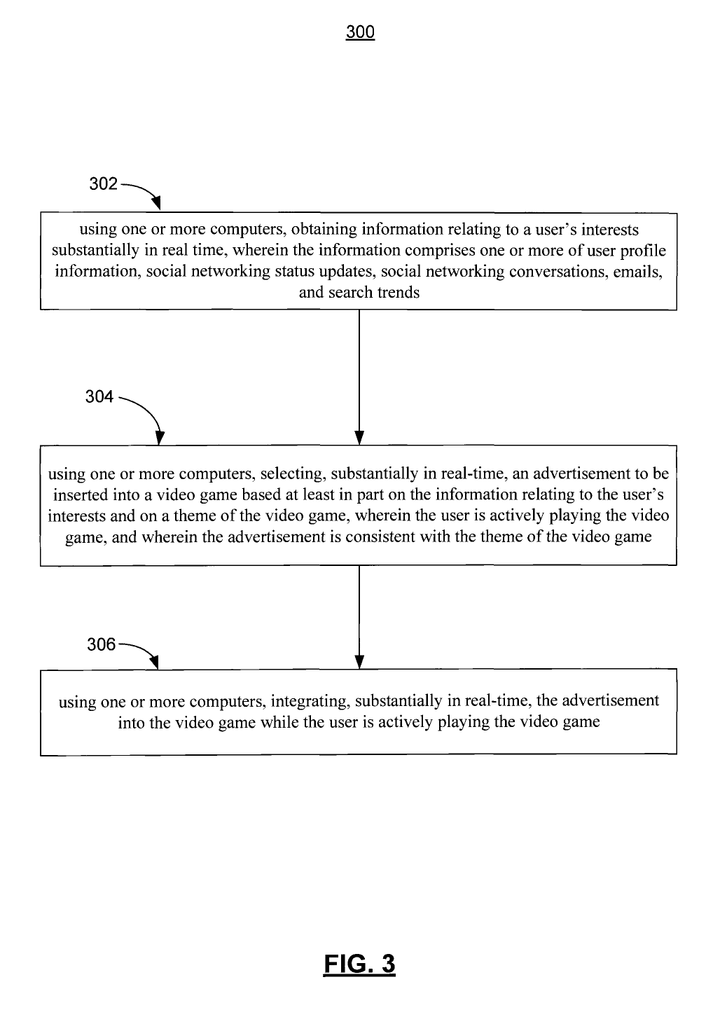

FIG. 3 is a flow diagram illustrating a method 300 according to one embodiment of the invention. At step 302, using one or more computers, information relating to a user's interests may be obtained substantially in real time, wherein the information comprises one or more of user profile information, social networking status updates, social networking conversations, emails, and search trends.

At step 304, using one or more computers, an advertisement to be inserted into a video game may be selected substantially in real time based at least in part on the information relating to the user's interests and on a theme of the video game, wherein the user is actively playing the video game, and wherein the advertisement is consistent with the theme of the video game.

At step 306, using one or more computers, the advertisement may be integrated substantially in real time into the video game while the user is actively playing the video game.

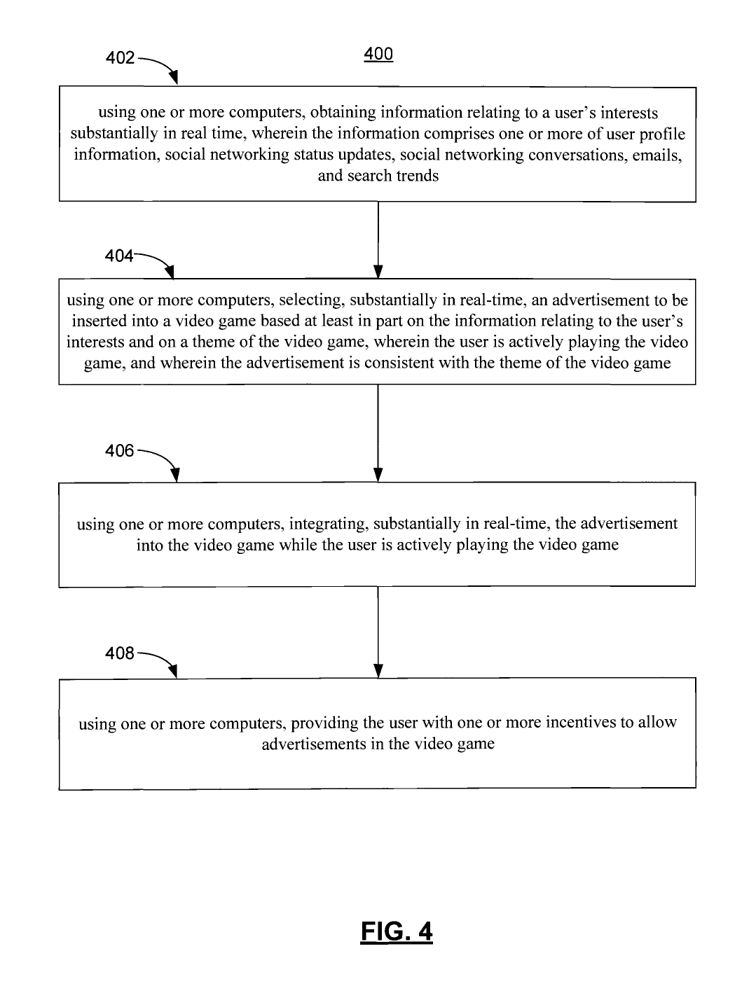

FIG. 4 is a flow diagram illustrating a method 400 according to one embodiment of the invention. At step 402, using one or more computers, information relating to a user's interests may be obtained substantially in real time, wherein the information comprises one or more of user profile information, social networking status updates, social networking conversations, emails, and search trends. At step 404, using one or more computers, an advertisement to be inserted into a video game may be selected, substantially in real-time, based at least in part on the information relating to the user's interests and on a theme of the video game, wherein the user is actively playing the video game, and wherein the advertisement is consistent with the theme of the video game.

At step 406, using one or more computers, the advertisement may be integrated, substantially in real-time, into the video game while the user is actively playing the video game. At step 408, using one or more computers, the user may be provided with one or more incentives to allow advertisements in the video game.

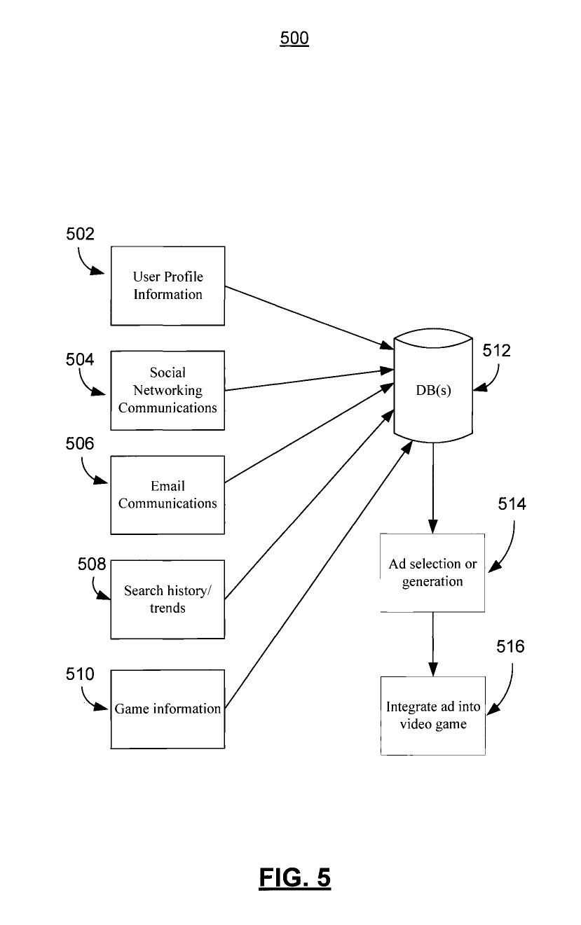

FIG. 5 is a block diagram 500 illustrating one embodiment of the invention. One or more data stores or databases 512 are depicted. Various types of information are stored in the database 512. In particular, types of depicted information stored in the database 512 include, potentially among many other types of information, user profile information 502, social networking communication information 504, email communication information 506, search history/trend information 508, and game information 510. User profile information 502 may include information such as the user's age, geographic location, education level, ethnicity, etc. Game information 510 may include for example, title (e.g., name), theme, genre, parental rating, etc. The information stored in database 512 may be obtained, gathered, or generated in various ways from various sources including directly from user computers, or from third party sources (e.g., game developers, social networking sites, etc.).

Block 514 represents generation or selection of an advertisement, targeted to a user who is actively playing a video game. The advertisement may be generated or selected based at least in part on one or more of obtained information 502-510. In some embodiments, a previously generated advertisement may be provided by one or more advertiser computers and stored in database 512. The advertisement may be selected based at least in part on rules or criteria (specified by the advertiser) related to one or more of obtained information 502-510.

Block 516 represents integration of the selected or generated advertisement into the video game. The advertisement may be displayed, for example, on a billboard in a scene in the video game.

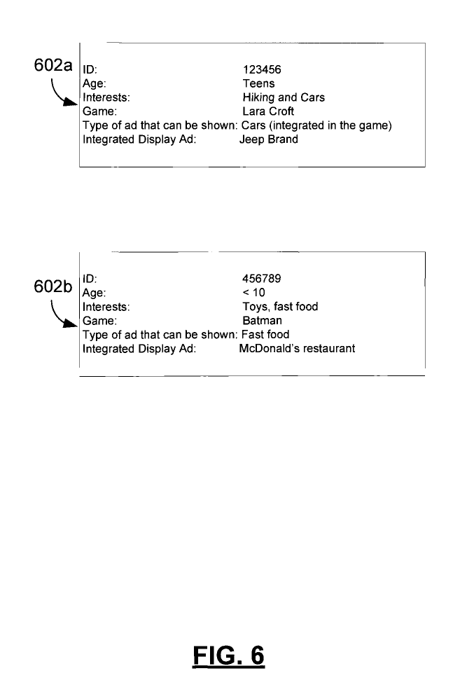

FIG. 6 is a block diagram illustrating exemplary data structures according to one embodiment of the invention. Data structures 602a and 602b, which illustrate the type of information that may be stored for a user, may be stored in, for example, database 512 (FIG. 5).

The exemplary use case scenarios listed below further describe embodiments of the invention.

User Case 1: User A is searching for a new lawn mower using the Yahoo Search engine. This information is tagged to the user, and as the user plays a game that is connected to the interne like the soccer game FIFA 2011, the system dynamically generates ads within the game containing deals of the latest lawn mowers. The ad may be integrated into the game such that as the commentator comments on the game, the commentator may mention the deals. Alternatively, or in addition, when the game hits a half time intermission, there may be a video ad displayed.

User Case 2: If user A is sending love messages through a social network platform to user B, then the system may detect this pattern and trigger ads that expresses love and feelings to both/either user A and B through a game that they might be playing after their communication. Ads that may be triggered by this include, for example, flowers, food, entertainment, etc.

User Case 3: It may be determined through the user's profile that the user is a fan of soccer and movies. While the user is playing a medieval time role-playing game the system may attempt to integrate an ad that will capture the interest of the user. Matching the type of game with the ad, it may be concluded that soccer does not match the type of game and hence will not be a good choice. Movies are a similar situation, but a specific type of movie may be an option.

An exemplary algorithm used to select the type of ads, and when to show it is described below.

```
Show Video Ad IF
    there is an available intermission on the game (Sample games: FIFA,
    NBA, MLB)
ELSE Show display Ads IF
    ((no intense user key sequence required) AND (no immediate
    response time needed)) (sample: detective games)
ELSE Display (Audio Ad) IF
    no interference of audio game dialog or story telling (sample:
    WarCraft, StarCraft)
ELSE Display (Textual Ad)
```

While the invention is described with reference to the above drawings, the drawings are intended to be illustrative, and the invention contemplates other embodiments within the spirit of the invention.

1. A method comprising:
using one or more computers, obtaining information relating to a user's interests;
using one or more computers, selecting, substantially in real-time, an advertisement to be inserted into a video game based at least in part on the information relating to the user's interests and on a theme of the video game, wherein the user is actively playing the video game; and
using one or more computers, integrating, substantially in real-time, the advertisement into the video game while the user is actively playing the video game.

2. The method of claim 1, wherein the information relating the user's interest comprises one or more of user profile information, social networking status updates, social networking conversations, emails, and search trends.

3. The method of claim 1, wherein selecting the advertisement comprises selecting the advertisement such that the advertisement is consistent with the theme of the video game.

4. The method of claim 1, wherein selecting the advertisement comprises selecting the advertisement such that the advertisement is relevant to the user's interests.

5. The method of claim 1, wherein the advertisement is click-able from the video game.

6. The method of claim 5, wherein clicking the advertisement from the video game allows the user to access the advertisement directly from the video game.

7. The method of claim 1, further comprising:
using one or more computers, providing the user with one or more incentives to allow advertisements in the video game.

8. The method of claim 7, wherein the incentives comprise one or more of game credits, deals, coupons, cash rewards and rewards points.

9. The method of claim 1, further comprising:
using one or more computers, tracking the user's interests by obtaining information relating to the user's interests substantially in real time.

10. A system comprising:
one or more server computers coupled to a network; and
one or more databases coupled to the one or more server computers;
wherein the one or more server computers are for:
obtaining information relating to a user's interests;
selecting, substantially in real-time, an advertisement to be inserted into a video game based at least in part on the information relating to the user's interests and on a theme of the video game, wherein the user is actively playing the video game; and
integrating, substantially in real-time, the advertisement into the video game while the user is actively playing the video game.

11. The system of claim 10, wherein the information relating the user's interest comprises one or more of user profile information, social networking status updates, social networking conversations, emails, and search trends.

12. The system of claim 10, wherein selecting the advertisement comprises selecting the advertisement such that the advertisement is consistent with the theme of the video game.

13. The system of claim 10, wherein selecting the advertisement comprises selecting the advertisement such that the advertisement is relevant to the user's interests.

14. The system of claim 10, wherein the advertisement is click-able from the video game.

15. The system of claim 14, wherein clicking the advertisement from the video game allows the user to access the advertisement directly from the video game.

16. The system of claim 10, wherein the server computers are further configured for:
providing the user with one or more incentives to allow advertisements in the video game.

17. The system of claim 16, wherein the incentives comprise one or more of game credits, deals, coupons, cash rewards and rewards points.

18. The system of claim 10, wherein the server computers are further configured for:
tracking the user's interests by obtaining information relating to the user's interests substantially in real time.

19. The system of claim 10, wherein the advertisements comprise one or more of textual data, audio data, video data, and graphical data.

20. A computer readable medium or media containing instructions for executing a method comprising:
using one or more computers, obtaining information relating to a user's interests in real time, wherein the information comprises one or more of user profile information, social networking status updates, social networking conversations, emails, and search trends;
using one or more computers, selecting, substantially in real-time, an advertisement to be inserted into a video game based at least in part on the information relating to the user's interests and on a theme of the video game, wherein the user is actively playing the video game, and wherein the advertisement is consistent with the theme of the video game; and
using one or more computers, integrating, substantially in real-time, the advertisement into the video game while the user is actively playing the video game.
